(19) United States
(12) Patent Application Publication
(10) Pub. No.: US 2025/0019247 A1
(43) Pub. Date: Jan. 16, 2025

(54) TWO-DIMENSIONAL POROUS SILICON, AND PREPARATION METHOD AND USE THEREOF IN LITHIUM ION BATTERIES

(71) Applicant: SHANDONG UNIVERSITY, Jinan (CN)

(72) Inventors: Jinkui FENG, Jinan (CN); Juan GENG, Jinan (CN)

(73) Assignee: SHANDONG UNIVERSITY, Jinan (CN)

(21) Appl. No.: 18/629,219

(22) Filed: Apr. 8, 2024

(30) Foreign Application Priority Data
Jul. 10, 2023 (CN) 2023108376905

(51) Int. Cl. C01B 33/021; H01M 10/0525

(52) U.S. Cl. CPC C01B 33/021; H01M 10/0525; C01P 2004/03; C01P 2004/20; C01P 2006/40

(57) ABSTRACT

A two-dimensional porous silicon, and a preparation method and use thereof in lithium ion batteries. A silicocalcium powder is soaked in a hydrochloric acid solution, filtered under suction after reaction, and dried to obtain a siloxene powder. The siloxene powder is thermally treated in a vacuum environment, in which siloxene is oxidized into SiOₓ during the heating process, and SiOₓ is disproportionated in further high-temperature treatment to produce uniformly distributed two-dimensional Si/SiO₂. The two-dimensional Si/SiO₂ is soaked in a hydrofluoric acid solution, in which hydrofluoric acid reacts with SiO₂. After complete reaction, a two-dimensional silicon material having a porous structure is obtained after repeatedly centrifugation and washing, and drying under vacuum. The two-dimensional porous silicon has a crystal structure and an ultra-thin lamellar structure, effectively alleviate the volume change of the negative electrode material, and accelerate the diffusion of lithium ions when used in a lithium ion battery.

### TECHNICAL FIELD

The present invention relates to the technical field of materials, and particularly to a two-dimensional porous silicon and a preparation method and use thereof in lithium ion batteries.

### BACKGROUND

Information disclosed in the background section is merely for the purpose of facilitating the understanding of the general background of the present invention and is not necessarily to be taken as an acknowledgment or any form of suggestion that the information constitutes prior art that is already known to those of ordinary skill in the art.

Silicon material has a high theoretical specific capacity, and is one of the most potential negative electrode materials for lithium ion batteries. However, the volume change of silicon anode is as high as 300% in the process of lithium intercalation, causing breaking of particles and falling off of active substances from the electrode. These lead to the rapid decline of the battery capacity. Two-dimensional porous structures can effectively alleviate the volume expansion of silicon materials during charging and discharging, and provide more lithium ion transmission channels, to improve the lithium ion transmission rate. Therefore, two-dimensional porous silicon materials are widely used as silicon negative electrodes. Patent No. CN 115403046 A discloses a two-dimensional silicon, having a two-dimensional structure in which the ions are transmitted at a lower speed in the direction perpendicular to the lamellar structure, which hinders its use in batteries.

Therefore, it is of great significance to optimize the properties of two-dimensional porous silicon and the transmission speed of feeding ions in the material.

### SUMMARY

To overcome the shortcomings in the prior art, an object of the present invention provides a two-dimensional porous silicon, and a preparation method and use thereof in lithium ion batteries. According to the preparation method of the two-dimensional porous silicon of the present invention, the two-dimensional porous silicon obtained by acid etching can accelerate the transmission of ions in the material, and the preparation method is simple, practical and easy to popularize.

To achieve the above object, the following technical solutions are employed in the present invention.

In a first aspect of the present invention, a method for preparing a two-dimensional porous silicon is provided. The method includes the following steps:
soaking a silicocalcium powder in an acidic solution, filtering under suction, and drying under vacuum to obtain a siloxene powder;
thermally treating the siloxene powder in a vacuum environment to obtain two-dimensional Si/SiO₂; and
soaking the two-dimensional Si/SiO₂ in a hydrofluoric acid solution, centrifuging, and drying under vacuum, to obtain the two-dimensional porous silicon material.

In some embodiments of the present invention, the silicocalcium powder has a chemical formula of CaSi₂.

In some embodiments of the present invention, the acidic solution includes one of hydrochloric acid, sulfuric acid, oxalic acid, nitric acid, perchloric acid, hypochlorous acid, and phosphoric acid.

In some embodiments of the present invention, the acid is a hydrochloric acid solution with a concentration of 12-37 wt %.

In some embodiments of the present invention, during the drying under vacuum, the temperature is 60-80° C., the time is 8-12 h, and the vacuum level is 0.2-0.5 Pa.

In some embodiments of the present invention, during the thermal treatment process, the temperature is 300-1000° C., and the time is 6-15 h. Preferably, during the thermal treatment process, gradient heating is employed. In the heating process, siloxene can be fully oxidized into SiOₓ, and SiOₓ is disproportionated in further high-temperature treatment to produce uniformly distributed two-dimensional Si/SiO₂. Compared with holding at a fixed temperature, gradient heating makes the reaction more complete, to improve the yield of the two-dimensional porous silicon.

In some embodiments of the present invention, the concentration of the hydrofluoric acid solution is 5-15 wt %. Silicon dioxide produced in the disproportionation process can be removed by hydrofluoric acid, to obtain the two-dimensional porous silicon after reaction.

In some embodiments of the present invention, the mass-volume ratio of the two-dimensional Si/SiO₂ to the hydrofluoric acid solution is 0.6 g: 40-120 mL.

In a second aspect of the present invention, a two-dimensional porous silicon prepared by the method for preparing a two-dimensional porous silicon is provided.

In a third aspect of the present invention, use of the two-dimensional porous silicon in lithium batteries is provided. Preferably, the use includes use of the two-dimensional porous silicon as a negative electrode of a lithium battery.

The present invention has the following beneficial effects.

(1) The precursors used in the invention are all commercial samples, and the preparation method is simple and controllable, thus having great potential for use in the negative electrodes of lithium ion batteries.

(2) The two-dimensional porous silicon of the present invention is produced by converting silicocalcium into siloxene by a topological chemical reaction. Siloxene will be oxidized into SiOₓ during the heating process, and SiOₓ is disproportionated in further high-temperature treatment to produce uniformly distributed two-dimensional Si/SiO₂. Silicon dioxide produced in the disproportionation process can be removed by hydrofluoric acid. The two-dimensional porous silicon prepared by this method has a crystal structure and an ultra-thin lamellar structure.

Patent No. CN 115403046 A provides a two-dimensional silicon prepared by a thermal reaction of calcium in silicocalcium with nitrogen acting as a reactant to remove calcium element, and removal of the produced calcium nitride by dilute hydrochloric acid. In this method, SiOₓ is disproportionated at a high temperature, and the generated SiO₂ can be removed by hydrofluoric acid, to obtain the two-dimensional porous silicon after reaction. According to the preparation method of the two-dimensional porous silicon of the present invention, the two-dimensional porous silicon obtained by acid etching can accelerate the transmission of ions in the material, and the production process is simple, practical and easy to popularize.

(3) When the two-dimensional porous silicon is used in a lithium ion battery, the volume change of the negative electrode material can be effectively alleviated, and the diffusion of lithium ions can be accelerated.

### BRIEF DESCRIPTION OF THE DRAWINGS

The accompanying drawings consisting a part of the present invention are intended to provide further understanding of the present invention and the schematic embodiments and description thereof in the present invention are provided for explaining the present invention, and do not constitute a restriction on the present invention.

FIG. 1 is an SEM image of siloxene produced by the reaction of silicocalcium with hydrochloric acid in Example 1.

FIG. 2 is an SEM image of Si/SiO₂ obtained after thermal treatment of siloxene in Example 1.

FIG. 3 is an SEM image of a two-dimensional porous silicon prepared in Example 1.

FIG. 4 shows the cycle performance of a two-dimensional Si/SiO₂ negative electrode prepared in Example 1.

FIG. 5 shows the columbic efficiency of the two-dimensional Si/SiO₂ negative electrode prepared in Example 1.

### DETAILED DESCRIPTION

It should be noted that the following detailed description is exemplary and is intended to provide a further description of the present invention. Unless otherwise indicated, all technical and scientific terms used herein have the same meaning as commonly understood by one of ordinary skill in the art to which the present invention belongs.

A method for preparing a two-dimensional porous silicon includes the following steps:
(1) soaking a silicocalcium powder in an acidic solution, filtering under suction, and drying under vacuum to obtain a siloxene powder;
(2) thermally treating the siloxene powder in a vacuum environment to obtain two-dimensional Si/SiO₂; and
(3) soaking the two-dimensional Si/SiO₂ in a hydrofluoric acid solution, centrifuging, and drying under vacuum to obtain the two-dimensional porous silicon.

In some embodiments, during the thermal treatment process, the temperature is 300-1000° C., and the time is 6-15 h.

In some embodiments, the hydrochloric acid solution has a concentration of 12-37 wt %.

In some embodiments, the concentration of the hydrofluoric acid solution is 5-15 wt %.

In some embodiments, the mass-volume ratio of the reaction product to hydrofluoric acid is 0.6:40-120 (g: mL).

In some embodiments, during the drying under vacuum, specifically, the temperature is 60-80° C., the time is 8-12 h, and the vacuum level is 0.2-0.5 Pa.

To enable those skilled in the art to more clearly understand the technical solutions of the present invention, the technical solutions of the present invention will be described in detail below in conjunction with specific examples.

### Example 1

A two-dimensional porous silicon was prepared as follows.

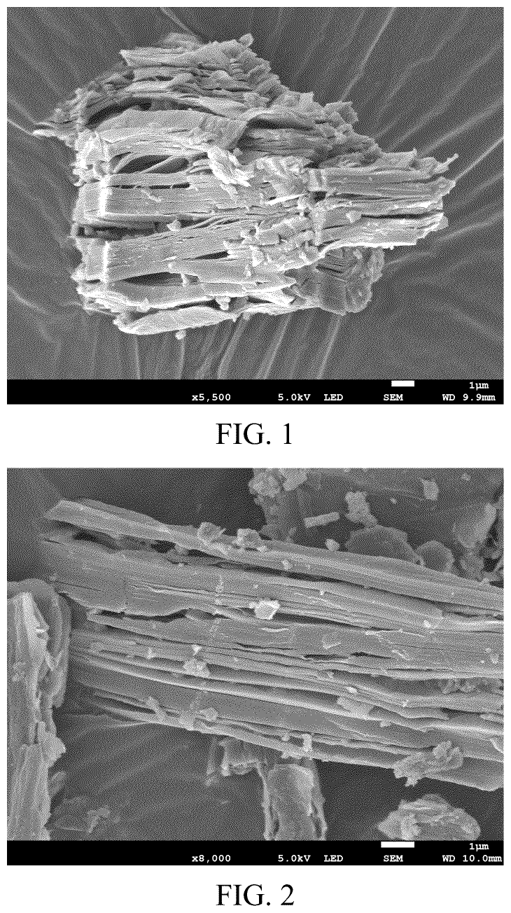

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder. FIG. 1 is an SEM image of siloxene, in which the lamellar structure confirms the successful preparation of siloxene.

(2) The siloxene powder was heated at a rate of 5° C. min-1 in a vacuum environment, and held at 300° C., 400° C. and 900° C. respectively for 3 h, 2 h, and 1 h to obtain two-dimensional Si/SiO₂. The SEM image of two-dimensional Si/SiO₂ in FIG. 2 also shows a two-dimensional structure.

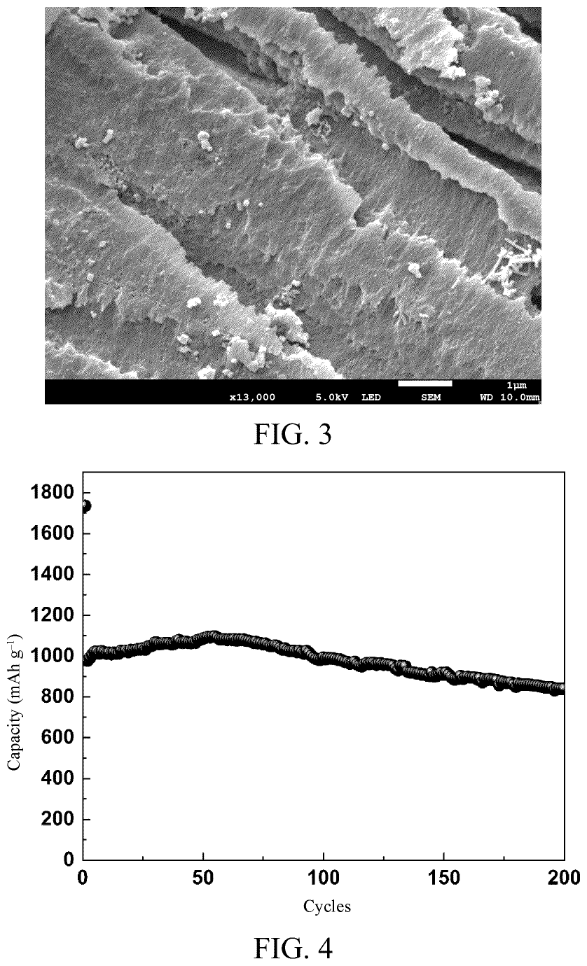

(3) 0.6 g of the two-dimensional Si/SiO₂ was soaked in 50 mL of a 10 wt % hydrofluoric acid solution, centrifuged, and dried for 12 h at 80° C. under vacuum with a vacuum level of 0.2 Pa, to obtain the two-dimensional porous silicon. The SEM image of two-dimensional porous silicon in FIG. 3 shows that SiO₂ in the two-dimensional Si/SiO₂ is successfully etched away, and the sample presents a two-dimensional porous structure.

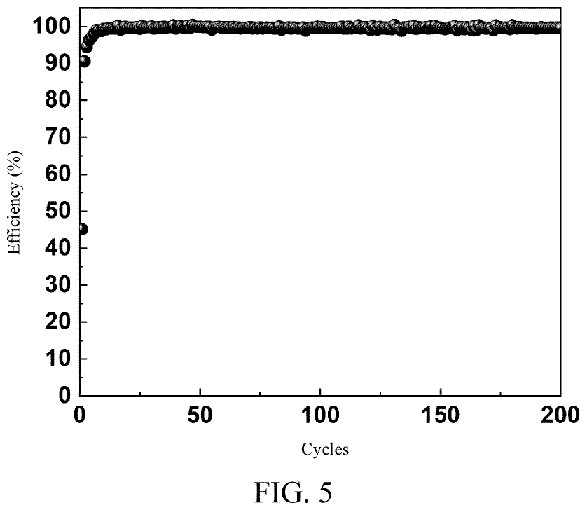

(4) The two-dimensional porous silicon was used as a negative electrode active material, a lithium sheet was used as a counter electrode and a reference electrode, the electrolyte solution was 1 M LiPF6+DC:DEC (1:1) with 10% FEC, and the voltage interval was 0.01V-3.0V. FIGS. 4 and 5 show that after 200 cycles at a test condition including a current density of 200 mA g⁻¹, the battery capacity is 838.4 mAh g⁻¹, and the columbic efficiency is 99.58%, confirming that the material has good electrochemical performance.

### Example 2

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 5° C. min⁻¹ in a vacuum environment, and held at 300° C., 800° C. and 900° C. respectively for 2 h, 2 h, and 2 h to obtain two-dimensional Si/SiO₂.

(3) 0.6 g of the two-dimensional Si/SiO₂ was soaked in 50 mL of a 10 wt % hydrofluoric acid solution, centrifuged, and dried for 12 h at 80° C. under vacuum with a vacuum level of 0.2 Pa, to obtain the two-dimensional porous silicon.

### Example 3

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 5° C. min⁻¹ in a vacuum environment, and held at 300° C., 800° C., and 1000° C. respectively for 2 h, 2 h, and 2 h to obtain two-dimensional Si/SiO₂.

(3) 0.6 g of the two-dimensional Si/SiO₂ was soaked in 50 mL of a 10 wt % hydrofluoric acid solution, centrifuged, and dried for 12 h at 80° C. under vacuum with a vacuum level of 0.2 Pa, to obtain the two-dimensional porous silicon.

### Example 4

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 5° C. min-1 in a vacuum environment, and held at 300° C., 400° C. and 900° C. respectively for 3 h, 2 h, and 3 h to obtain two-dimensional Si/SiO₂.

(3) 0.6 g of the two-dimensional Si/SiO₂ was soaked in 50 mL of a 10 wt % hydrofluoric acid solution, centrifuged, and dried for 12 h at 80° C. under vacuum with a vacuum level of 0.2 Pa, to obtain the two-dimensional porous silicon.

### Example 5

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 10° C. min⁻¹ in a vacuum environment, and held at 300° C., 400° C. and 900° C. respectively for 3 h, 2 h, and 6 h to obtain two-dimensional Si/SiO₂.

(3) 0.6 g of the two-dimensional Si/SiO₂ was soaked in 50 mL of a 15 wt % hydrofluoric acid solution, centrifuged, and dried for 12 h at 80° C. under vacuum with a vacuum level of 0.2 Pa, to obtain the two-dimensional porous silicon.

### Example 6

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 10° C. min⁻¹ in a vacuum environment, and held at 300° C., 800° C. and 1000° C. respectively for 3 h, 2 h, and 6 h to obtain two-dimensional Si/SiO₂.

(3) 0.6 g of the two-dimensional Si/SiO₂ was soaked in 50 mL of a 15 wt % hydrofluoric acid solution, centrifuged, and dried for 12 h at 80° C. under vacuum with a vacuum level of 0.2 Pa, to obtain the two-dimensional porous silicon.

Example 7

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 10° C. min⁻¹ in a vacuum environment, and held at 300° C., 800° C. and 900° C. respectively for 3 h, 2 h, and 1 h to obtain two-dimensional Si/SiO₂.

(3) 0.6 g of the two-dimensional Si/SiO₂ was soaked in 50 mL of a 15 wt % hydrofluoric acid solution, centrifuged, and dried for 12 h at 80° C. under vacuum with a vacuum level of 0.2 Pa, to obtain the two-dimensional porous silicon.

### Example 8

A two-dimensional porous silicon was prepared as follows.

(1) A silicocalcium powder was soaked in a 37 wt % concentrated hydrochloric acid solution, filtered under suction, and dried for 12 h at 80° C. under vacuum with a vacuum level of 0.2 Pa, to obtain a siloxene powder.

(2) The siloxene powder was heated at a rate of 5° C. min⁻¹ in a vacuum environment, and held at 300° C., 800° C. and 900° C. respectively for 2 h, 2 h, and 6 h to obtain two-dimensional Si/SiO₂.

(3) 0.6 g of the two-dimensional Si/SiO₂ was soaked in 50 mL of a 15 wt % hydrofluoric acid solution, centrifuged, and dried for 12 h at 80° C. under vacuum with a vacuum level of 0.2 Pa, to obtain the two-dimensional porous silicon.

Preferred embodiments of the present invention have been described above; however, the present invention is not limited thereto. Various variations and changes can be made by those skilled in the art to the present invention. Any modification, equivalent substitution, and improvement made without departing from the spirit and principle of the present invention are intended to be included within the scope of the present invention.

1. A method for preparing a two-dimensional porous silicon, comprising:
soaking a silicocalcium powder in an acidic solution, filtering under suction, and drying under vacuum to obtain a siloxene powder;
thermally treating the siloxene powder in a vacuum environment to obtain two-dimensional Si/SiO₂; and
soaking the two-dimensional Si/SiO₂ in a hydrofluoric acid solution, centrifuging, and drying under vacuum, to obtain the two-dimensional porous silicon material.

2. The method for preparing a two-dimensional porous silicon according to claim 1, wherein the silicocalcium powder has a chemical formula of CaSi₂.

3. The method for preparing a two-dimensional porous silicon according to claim 1, wherein the acidic solution comprises one of hydrochloric acid, sulfuric acid, oxalic acid, nitric acid, perchloric acid, hypochlorous acid, and phosphoric acid.

4. The method for preparing a two-dimensional porous silicon according to claim 1, wherein the acid solution is hydrochloric acid solution with a concentration of 12-37 wt %.

5. The method for preparing a two-dimensional porous silicon according to claim 1, wherein conditions for the drying under vacuum comprise a temperature of 60-80° C., a duration of 8-12 hours, and a vacuum level of 0.2-0.5 Pa.

6. The method for preparing a two-dimensional porous silicon according to claim 1, wherein conditions for the thermally treating comprise a temperature of 300-1000° C. for a duration of 6-15 hours.

7. The method for preparing a two-dimensional porous silicon according to claim 1, wherein a concentration of the hydrofluoric acid solution is 5-15 wt %.

8. The method for preparing a two-dimensional porous silicon according to claim 1, wherein a mass-volume ratio of the two-dimensional Si/SiO₂ to the hydrofluoric acid solution is 0.6 g: 40-120 mL.

9. A two-dimensional porous silicon prepared by the method for preparing a two-dimensional porous silicon according to claim 1.

10. The method for preparing the two-dimensional porous silicon according to claim 9 in lithium batteries.
